(19) United States
(12) Patent Application Publication
(10) Pub. No.: US 2026/0141396 A1
(43) Pub. Date: May 21, 2026

(54) ADAPTIVE CLOUD-BASED FRAUD DETECTION SYSTEM AND METHOD USING DYNAMIC TRANSACTION WINDOWS

(71) Applicants: Himani FNU, Naperville, IL (US); Md Maksudul AMIN, Franklin Square, NY (US); Shekar VOLLEM, Aubrey, TX (US); Anshul BAKODE, Plano, TX (US)

(72) Inventors: Himani FNU, Naperville, IL (US); Md Maksudul AMIN, Franklin Square, NY (US); Shekar VOLLEM, Aubrey, TX (US); Anshul BAKODE, Plano, TX (US)

(21) Appl. No.: 19/441,612

(22) Filed: Jan. 6, 2026

(51) Int. Cl. G06Q 20/40

(52) U.S. Cl. CPC G06Q 20/4016

(57) ABSTRACT

An adaptive cloud-based fraud detection system and method provide real-time monitoring and analysis of electronic transactions using dynamic transaction windows. The system receives transaction events from distributed transaction sources and dynamically constructs transaction observation windows whose temporal and event-based boundaries are continuously adjusted based on observed transaction behavior, contextual indicators, and evolving risk states associated with monitored entities. Transaction attributes within dynamic transaction windows are correlated with adaptive behavioral baselines to compute fraud risk states without reliance on fixed temporal intervals or static thresholds. Based on the computed fraud risk states, real-time transaction control decisions including approval, rejection, or conditional verification are generated. The system operates within a distributed cloud computing environment and allocates processing resources adaptively to maintain scalability, fault tolerance, and low-latency decisioning. By dynamically aligning transaction analysis with real-world patterns, fraud detection accuracy improves and false positives and computational overhead in transaction processing systems are reduced.

### TECHNICAL FIELD OF THE INVENTION

The present invention relates to the field of computerized fraud detection and prevention, and more particularly to an adaptive cloud-based computing system and corresponding method for detecting fraudulent activities in electronic transactions by dynamically adjusting transaction observation windows based on real-time behavioral, contextual, and risk-driven parameters. The invention further relates to a specialized computing device and machine structure configured to execute adaptive fraud analysis logic in distributed cloud environments.

### BACKGROUND OF THE INVENTION

Electronic transaction systems have become an essential component of modern financial, commercial, and digital service infrastructures, enabling real-time processing of payments, transfers, account operations, and service authorizations across geographically distributed networks. With the growth of online banking, e-commerce platforms, digital wallets, and automated financial services, the volume, velocity, and diversity of transactions have increased substantially, thereby amplifying the complexity of detecting fraudulent behavior. Conventional fraud detection systems typically rely on static rule sets, fixed transaction thresholds, or predefined temporal analysis windows to evaluate transaction legitimacy. Such systems often analyze transactions within a fixed time interval or fixed count-based window, irrespective of user behavior, transaction context, or evolving fraud patterns.

These static approaches suffer from multiple limitations. Fixed transaction windows may either be too narrow to capture slow-evolving fraudulent behavior or too broad, resulting in delayed detection and excessive false positives. Rule-based systems are often rigid, require frequent manual updates, and fail to adapt to emerging fraud strategies. Centralized systems with monolithic architectures struggle to scale efficiently in cloud environments and are unable to incorporate real-time contextual intelligence, such as device behavior, geospatial variation, transaction velocity changes, or historical behavioral drift. As a result, existing solutions either compromise detection accuracy or impose excessive computational overhead, leading to increased operational costs and degraded user experience.

There is therefore a technical need for an adaptive fraud detection system that dynamically adjusts transaction analysis windows in real time, leverages cloud-based distributed processing, and continuously adapts to changing transaction patterns without reliance on static rules or fixed temporal constraints. The present invention addresses these deficiencies by introducing a cloud-based adaptive fraud detection architecture that employs dynamic transaction windows governed by transaction behavior, contextual risk indicators, and continuous model feedback.

Fraud detection for digital transactions has evolved from simple threshold checks into complex, multi-signal, near-real-time decision systems deployed across payment networks, banking channels, e-commerce platforms, digital wallets, and service authorization gateways. The technical problem is driven by the scale and heterogeneity of modern transaction streams, where legitimate activity and malicious activity can be statistically similar at the individual event level, but diverge when viewed across sequences, context, and behavioral drift over time. As transaction processing has moved to cloud-based and hybrid architectures, fraud detection must operate under strict latency constraints, often within milliseconds to a few seconds, while processing very high throughput and maintaining strong consistency of entity state across distributed nodes. At the same time, adversaries exploit automation, compromised identities, synthetic identities, bot-driven testing, account takeovers, mule networks, and coordinated attacks that deliberately shape transaction sequences to evade fixed rules, fixed thresholds, and static observation strategies.

A widely used class of existing solutions is static rule-based fraud screening, in which transaction attributes are compared against a configurable set of deterministic conditions. These systems typically encode business logic such as amount thresholds, merchant category constraints, country blacklists, velocity caps, or mismatches between billing and shipping details. The main technical advantage is predictability and ease of deployment, but the limitations are structural. Rules are brittle under concept drift because legitimate user behavior changes over time, especially during seasonal peaks, travel, and new channel adoption, while fraud tactics change faster than manual rule updates. Rule engines often generate high false positive rates when tuned conservatively, and high false negative rates when tuned permissively, because the decision boundary is not learned from data but hand-specified. In addition, rule sets frequently grow into large, interdependent configurations that are hard to validate, leading to unintended interactions and maintenance complexity. Rule-based approaches also struggle with subtle fraud that relies on low-and-slow patterns spread across time or across accounts, because rules frequently evaluate individual transactions or short fixed intervals rather than adaptive multi-scale behavior.

Another common approach uses fixed transaction windows for velocity and aggregation features, such as counting the number of transactions in the last 5 minutes, summing the total value in the last 24 hours, or computing average amounts in a fixed lookback period. Fixed windows are attractive because they enable fast feature computation and are straightforward to operationalize. However, fraud does not conform to a single temporal signature. High-speed fraud such as card testing and bot-driven micro-transactions may occur in seconds, while account takeover and laundering may unfold over days or weeks. A window that is too short misses slow fraud, while a window that is too long dilutes meaningful signals and delays detection. Fixed windows also create boundary artifacts where a burst split across window edges appears benign, and they can be exploited by adversaries who schedule events to avoid crossing thresholds within any single window. Furthermore, fixed windows impose a uniform temporal lens on all entities, even though different users, merchants, and channels naturally exhibit different transaction rhythms. This mismatch increases both false alarms for high-activity legitimate entities and missed detections for low-activity entities where a small change can be significant.

Classical statistical anomaly detection methods have also been deployed, including z-score thresholding, robust statistics on transaction distributions, and change-point detection on transaction rates or amounts. While these techniques can detect deviations from historical norms, they rely on assumptions about stationarity and distribution shape that are frequently violated in real transaction streams. Legitimate behavior exhibits non-stationarity due to marketing campaigns, salary cycles, holidays, travel, device upgrades, and macroeconomic conditions. As a result, anomaly detectors can be overly sensitive to benign shifts and under-sensitive to adaptive adversaries who gradually shift behavior to avoid triggering abrupt changes. Additionally, many statistical approaches require clean baselines and sufficient history per entity; new accounts, sparse users, and cold-start merchants provide limited data, leading to poorly calibrated thresholds and inconsistent performance.

Machine learning-based fraud scoring has become the dominant paradigm in many institutions, using supervised models trained on labeled historical transactions. Common models include logistic regression, gradient-boosted decision trees, random forests, and deep neural networks, often operating on engineered features such as velocity metrics, device fingerprints, location consistency, and prior dispute history. While supervised learning improves detection by capturing nonlinear interactions and reducing reliance on manual rules, it introduces its own drawbacks. Training requires reliable labels, but fraud labels are often delayed, noisy, and biased because only detected cases are investigated and confirmed, and chargeback processes can take weeks. This label delay causes models to train on outdated patterns, and the bias causes models to overfit to historically visible fraud while missing novel attacks. Model performance can degrade under concept drift, requiring frequent retraining and careful monitoring. In addition, complex models can be difficult to explain and defend in operational and regulatory settings, leading to a dependence on post-hoc explainability methods that may not faithfully represent model reasoning. The risk of adversarial adaptation also remains, as attackers probe decision boundaries by making low-risk transactions to learn model responses.

Graph-based fraud detection solutions attempt to model relationships among entities such as accounts, devices, IP addresses, emails, merchants, and beneficiaries. These systems can identify fraud rings, mule networks, and coordinated behaviors that are not visible in isolated transaction scoring. However, graph approaches often have high computational and storage costs, especially when graphs must be updated in real time with streaming edges. Maintaining consistency of graph state across distributed nodes is challenging, and real-time inference on large graphs can introduce unacceptable latency for transaction authorization. Graph solutions also depend on high-quality entity resolution; if device identifiers, addresses, or user attributes are noisy or easily spoofed, the graph becomes fragmented or polluted, reducing detection efficacy. Additionally, graph methods frequently require periodic batch processing for community detection or embedding generation, which can lag behind real-time fraud dynamics.

Behavioral biometrics and device fingerprinting systems provide another layer by analyzing typing cadence, touch patterns, sensor signals, browser characteristics, and device configuration to determine whether a user's interaction matches historical behavior. These can be effective for account takeover detection and session integrity validation, but they have practical and technical drawbacks. Collection of high-fidelity behavioral signals may be constrained by privacy regulations, platform restrictions, and user consent. Fingerprints can be unstable due to OS updates, browser changes, network conditions, and accessibility tools, leading to false positives. Attackers can use emulators, automation tools, or compromised legitimate devices, which reduces fingerprint discriminative power. Moreover, these systems are often integrated as separate services that add latency and complexity to the authorization workflow.

Real-time stream processing architectures, using distributed messaging systems and cloud-native compute, have enabled scalable ingestion and feature computation. Many organizations implement feature stores and streaming aggregators to compute rolling metrics and serve them to scoring models. Despite this progress, existing architectures often still rely on fixed windowing primitives (tumbling or sliding windows) defined a priori. While stream processors support window operations efficiently, the window parameters are usually statically configured per pipeline and are not adjusted per entity based on risk. This rigidity leads to over-computation for low-risk entities and under-capture of relevant sequences for high-risk entities. Additionally, streaming systems face challenges with late-arriving events, out-of-order timestamps, duplicate messages, and retries, all of which can distort window aggregates. Ensuring exactly-once semantics and consistent state across failures requires complex checkpointing and state backend configurations, increasing operational overhead.

Hybrid systems combine rules, models, and human review, often routing borderline transactions to manual investigation. This reduces risk but introduces latency and cost. Human review pipelines are constrained by staffing and cannot scale linearly with transaction volume. Fraudsters exploit this by generating high volumes of borderline events to overload review capacity. Moreover, manual review decisions can be inconsistent, introducing label noise that degrades model training. Hybrid systems also tend to accumulate layered logic, where a model score is overridden by rules or vice versa, making system behavior difficult to predict and tune. When these systems operate across multiple channels, maintaining consistent fraud policy becomes challenging, as separate teams may configure divergent thresholds and exceptions.

A further limitation in many existing solutions is the inability to represent and act on uncertainty over time. Fraud risk is not static; it changes as new events occur, as context changes, and as more evidence accumulates. Yet many systems compute a point score per transaction, based on a fixed snapshot of features, and make an immediate decision without considering whether additional near-term evidence could disambiguate the risk. Some systems attempt multi-step verification, but the temporal logic is usually prescriptive rather than adaptive, and may not align with entity-specific behavior. As a result, legitimate users can face unnecessary friction from step-up authentication, while fraud can slip through when evidence accumulates slowly across a broader time span than the system is configured to observe.

Accordingly, the primary drawbacks of existing fraud detection solutions can be summarized as rigidity in temporal observation, reliance on static windows or static rules, susceptibility to concept drift and label delay, difficulty in scaling stateful entity monitoring in cloud environments, and inefficiencies caused by applying uniform analysis granularity across diverse entities and contexts. These limitations motivate the need for an adaptive approach that can dynamically shape transaction observation windows per entity and per risk state, maintain consistent state in distributed processing, and continuously recalibrate decision thresholds and evidence aggregation strategies in real time. Such an approach can reduce boundary artifacts, capture both burst and slow fraud patterns, allocate computation proportionally to risk, and better align detection logic with evolving behavioral signatures in modern cloud-based transaction ecosystems.

### SUMMARY OF THE INVENTION

The present invention provides an adaptive cloud-based fraud detection system and method that dynamically constructs, expands, contracts, and reconfigures transaction observation windows in real time based on transaction characteristics, user behavior profiles, contextual signals, and computed risk states. The system operates within a distributed cloud infrastructure and continuously evaluates incoming transaction streams using dynamically parameterized transaction windows rather than fixed time or count-based intervals. The invention further provides a dedicated computing device and machine structure configured to execute the adaptive windowing logic, risk computation processes, and fraud decision workflows in a scalable and fault-tolerant manner.

The system improves fraud detection accuracy by correlating transaction events across variable temporal spans tailored to individual entities, transaction types, and observed behavioral deviations. The method enables early detection of both high-velocity fraud attacks and low-and-slow fraudulent patterns while minimizing false positives for legitimate users. The machine structure integrates processing units, memory units, communication interfaces, and cloud orchestration components specifically arranged to support adaptive transaction window management and real-time fraud inference.

The primary object of the present invention is to provide an adaptive cloud-based fraud detection system and method that overcomes the limitations of static, rule-driven, and fixed-window fraud analysis techniques by dynamically adjusting transaction observation windows in real time based on transaction behavior, contextual signals, and continuously evaluated risk states. The invention seeks to enable accurate and timely detection of fraudulent activities across high-volume transaction streams while maintaining low latency and scalability within distributed cloud computing environments.

Another object of the invention is to provide a technically robust mechanism for constructing, expanding, contracting, and reconfiguring transaction windows on a per-entity basis, such that each user, account, device, or merchant is monitored using a temporal scope that reflects its individual transaction rhythm and behavioral variability. By tailoring transaction windows dynamically, the invention aims to capture both rapid, high-frequency fraud patterns and slow, low-intensity fraudulent behaviors that evolve over extended periods, which are often missed by fixed-window systems.

A further object of the invention is to enable continuous correlation of transaction events using adaptive behavioral baselines that evolve over time without reliance on manually defined thresholds or static rule sets. The invention seeks to reduce false positives arising from legitimate behavioral changes while improving sensitivity to subtle fraud patterns by recalibrating risk assessment parameters in response to verified outcomes and observed behavioral drift.

Another object of the invention is to provide a cloud-native fraud detection architecture that supports horizontal scalability, fault tolerance, and efficient resource utilization by distributing transaction window state and risk computations across multiple processing nodes. The invention aims to dynamically allocate computational resources based on transaction density and risk concentration, thereby optimizing system performance and reducing unnecessary processing overhead for low-risk entities.

An additional object of the invention is to deliver real-time fraud decisioning capabilities that integrate seamlessly with transaction authorization systems, enabling immediate approval, rejection, or conditional authentication actions within stringent transaction processing time constraints. The invention seeks to ensure that adaptive fraud analysis does not introduce unacceptable latency or disrupt normal transaction flows.

Another object of the invention is to provide a dedicated computing device and machine structure specifically configured to execute adaptive transaction window management, fraud risk computation, and decision orchestration in a secure and reliable manner. The invention aims to define a concrete hardware-oriented structure that supports cloud deployment while maintaining consistent state management and high availability.

A further object of the invention is to support continuous learning and system adaptation by incorporating feedback from confirmed transaction outcomes, thereby enabling long-term improvement in fraud detection accuracy without frequent manual reconfiguration. The invention seeks to provide a self-adjusting fraud detection mechanism capable of responding to evolving fraud strategies and changing transaction ecosystems.

Yet another object of the invention is to enhance explainability and operational control by associating fraud decisions with dynamically generated transaction window evidence, enabling auditors, analysts, and system operators to understand the temporal and behavioral context underlying each decision. The invention aims to improve trust, transparency, and governance in automated fraud detection systems deployed in regulated environments.

An additional object of the invention is to provide a unified fraud detection approach applicable across multiple transaction channels, including online payments, banking transactions, digital wallets, and service authorizations, without requiring separate static configurations for each channel. The invention seeks to ensure consistent fraud policy enforcement while allowing channel-specific behavioral adaptation through dynamic windowing.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of an adaptive cloud-based fraud detection system; and

FIG. 2 displays flow chart of a method for a method for adaptive cloud-based fraud detection using dynamic transaction windows.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

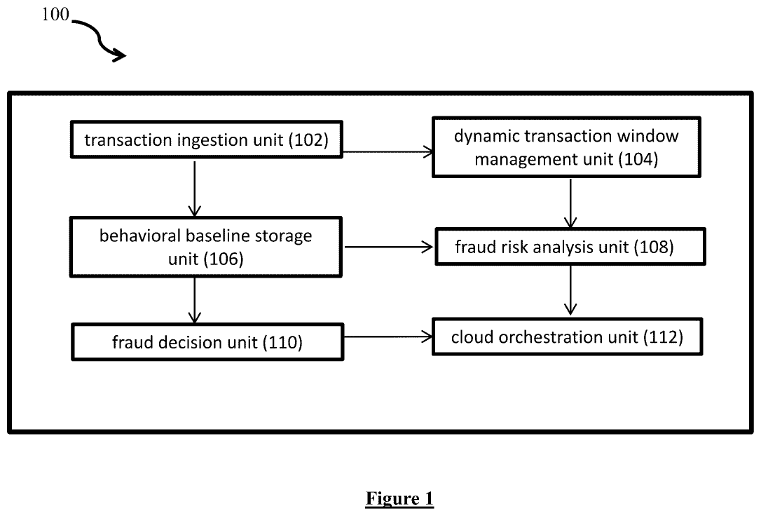

Referring to FIG. 1, a block diagram of an adaptive cloud-based fraud detection system is illustrated. The system 100 comprises: a transaction ingestion unit (102) configured to receive, normalize, and serialize electronic transaction events originating from one or more distributed transaction sources; a dynamic transaction window management unit (104) operatively coupled to the transaction ingestion unit and configured to construct, maintain, and update one or more transaction windows for each monitored entity, wherein each transaction window is defined by dynamically adjustable temporal and event-based boundaries determined in real time based on observed transaction behavior; a behavioral baseline storage unit (106) configured to store historical transaction representations associated with each monitored entity and to provide adaptive reference data reflecting evolving transaction patterns; a fraud risk analysis unit (108) operatively coupled to the dynamic transaction window management unit and the behavioral baseline storage unit, the fraud risk analysis unit being configured to compute a fraud risk state for each dynamically constructed transaction window by correlating transaction attributes within the window with corresponding behavioral baselines and contextual indicators; a fraud decision unit (110) configured to generate transaction authorization control signals based on the computed fraud risk state, the control signals comprising approval signals, rejection signals, or conditional verification signals; and a cloud orchestration unit (112) configured to distribute transaction windows and associated fraud risk computations across a plurality of processing nodes in a cloud computing environment while maintaining consistency of transaction window state.

In an embodiment, the dynamic transaction window management unit (104) is configured to vary at least one of a window duration, a window event count, and a window overlap characteristic independently for each monitored entity based on detected changes in transaction frequency, transaction value dispersion, or inter-transaction timing irregularity.

In an embodiment, the dynamic transaction window management unit (104) is further configured to generate multiple concurrent transaction windows for a single monitored entity, each transaction window corresponding to a different temporal granularity, and to supply the multiple concurrent transaction windows to the fraud risk analysis unit for parallel risk evaluation.

In an embodiment, the behavioral baseline storage unit (106) is configured to continuously update stored behavioral baselines by incorporating verified transaction outcomes and confirmed fraud decisions, thereby enabling adaptive recalibration of baseline transaction characteristics without manual configuration.

In an embodiment, the fraud risk analysis unit (108) is configured to compute the fraud risk state by evaluating transaction attribute correlations across dynamically evolving transaction windows rather than fixed-duration transaction intervals, thereby reducing boundary-related detection errors.

In an embodiment, the fraud risk analysis unit (108) is further configured to assign different computational weights to transaction attributes based on a current transaction context comprising transaction channel, device characteristics, geographic indicators, and historical entity behavior.

In an embodiment, the fraud decision unit (110) is configured to adjust decision thresholds dynamically based on an aggregated risk trend observed across successive transaction windows associated with a monitored entity.

In an embodiment, the cloud orchestration unit (112) is configured to allocate processing resources to transaction windows based on a computed complexity score derived from transaction density and window expansion characteristics.

In an embodiment, the cloud orchestration unit is further configured to replicate transaction window state information across multiple storage locations to preserve continuity of fraud analysis during processing node failures.

In an embodiment, the transaction ingestion unit (102) is configured to handle out-of-order transaction events by reassigning the events to appropriate dynamic transaction windows based on corrected temporal alignment.

The transaction ingestion unit, dynamic transaction window management unit, behavioral baseline storage unit, fraud risk analysis unit, fraud decision unit, and cloud orchestration unit recited in the claims are each implemented using tangible hardware components forming part of a cloud-based computing infrastructure. Specifically, the transaction ingestion unit comprises physical network interface hardware, communication controllers, and processor-coupled input buffers configured to receive electronic transaction events from distributed transaction sources and to perform normalization and serialization using processor-executed instructions operating on dedicated memory regions. The dynamic transaction window management unit is implemented through one or more physical processors, hardware timing circuits, and memory-resident data structures, including window state tables, timestamp registers, and event counters, which are continuously updated through processor instructions synchronized with system clocks to construct, maintain, and modify transaction windows in real time. The behavioral baseline storage unit comprises non-volatile storage devices, hardware storage controllers, and cache memory configured to persist historical transaction representations and to support frequent read-write operations for adaptive baseline updates based on verified outcomes. The fraud risk analysis unit is realized using arithmetic and logical processing hardware within one or more processors, operating on transaction data and baseline data retrieved from memory to perform correlation, contextual weighting, and fraud risk state computation. The fraud decision unit is implemented as processor-controlled decision logic interfacing with hardware output communication components to generate and transmit authorization control signals corresponding to approval, rejection, or conditional verification outcomes. The cloud orchestration unit comprises physically distinct computing nodes interconnected through hardware networking components, together with resource scheduling controllers, distributed memory, and storage replication hardware, enabling allocation of processing resources, synchronization of transaction window state, and replication of state information across multiple storage locations to maintain operational continuity during node failures.

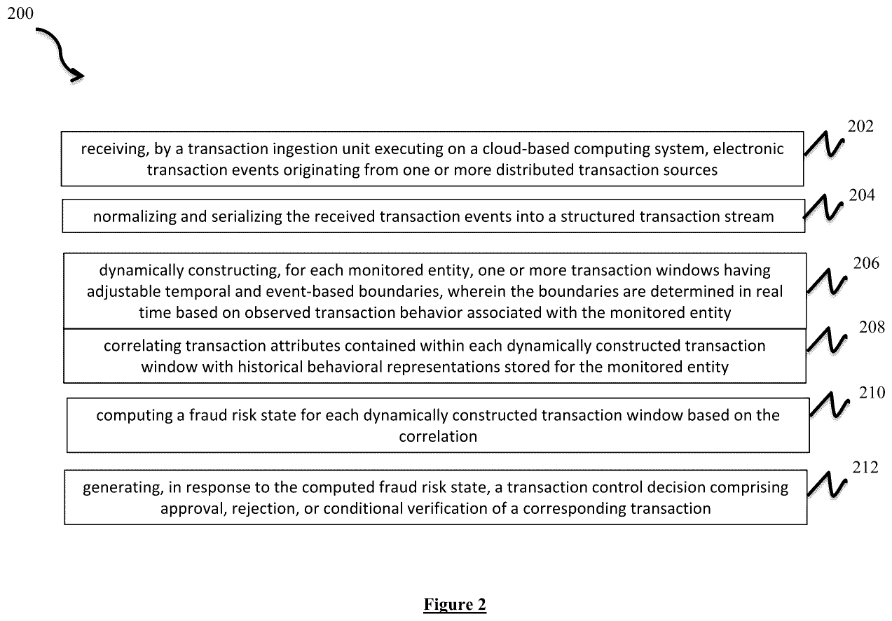

Referring to FIG. 2, a flow chart for a method for adaptive cloud-based fraud detection using dynamic transaction windows, comprising the steps of is illustrated. The method 200 is capable of being implemented by system illustrated in FIG. 1. The method 200 comprises:
At step 202, the method 200 includes receiving, by a transaction ingestion unit executing on a cloud-based computing system, electronic transaction events originating from one or more distributed transaction sources;
At step 204, the method 200 includes normalizing and serializing the received transaction events into a structured transaction stream;
At step 206, the method 200 includes dynamically constructing, for each monitored entity, one or more transaction windows having adjustable temporal and event-based boundaries, wherein the boundaries are determined in real time based on observed transaction behavior associated with the monitored entity;
At step 208, the method 200 includes correlating transaction attributes contained within each dynamically constructed transaction window with historical behavioral representations stored for the monitored entity;
At step 210, the method 200 includes computing a fraud risk state for each dynamically constructed transaction window based on the correlation; and
At step 212, the method 200 includes generating, in response to the computed fraud risk state, a transaction control decision comprising approval, rejection, or conditional verification of a corresponding transaction.

In an embodiment, dynamically constructing the transaction windows comprises adjusting at least one of a transaction window duration, a transaction window event count, and a transaction window overlap parameter in response to changes in transaction frequency, transaction value dispersion, or inter-transaction timing variability.

In an embodiment, dynamically constructing the transaction windows further comprises generating multiple concurrent transaction windows for a single monitored entity, each transaction window corresponding to a different temporal resolution, and performing fraud risk computation independently for each concurrent transaction window.

In an embodiment, correlating transaction attributes with historical behavioral representations comprises retrieving adaptive behavioral baselines that evolve over time based on previously verified transaction outcomes associated with the monitored entity.

In an embodiment, computing the fraud risk state comprises evaluating transaction attribute relationships across dynamically evolving transaction windows rather than across fixed-duration transaction intervals.

In an embodiment, computing the fraud risk state further comprises assigning context-dependent weights to transaction attributes based on transaction channel, device characteristics, geographic indicators, and historical entity behavior.

In an embodiment, generating the transaction control decision comprises dynamically adjusting a fraud decision threshold based on an aggregated trend of fraud risk states computed across successive transaction windows associated with the monitored entity.

In an embodiment, further comprising distributing dynamically constructed transaction windows and corresponding fraud risk computations across a plurality of processing nodes within a cloud computing environment while maintaining consistency of transaction window state.

In an embodiment, distributing the transaction windows comprises allocating processing resources based on a computed complexity indicator derived from transaction density within each transaction window.

In an embodiment, further comprising replicating transaction window state information across multiple storage locations to preserve continuity of fraud analysis during processing node failures.

In an embodiment, dynamically constructing the one or more transaction windows for each monitored entity comprises executing, by the cloud-based computing system, a continuous window adaptation routine that includes: maintaining, in an entity-specific state store, a time-ordered buffer of recent transaction timestamps extracted from the structured transaction stream; computing, for each newly received transaction event, a rolling inter-transaction interval series using differences between successive timestamps stored in the buffer; determining a short-term interval distribution from the rolling inter-transaction interval series; comparing the short-term interval distribution against a longer-term reference interval distribution previously derived for the monitored entity; and adjusting a temporal boundary of an active transaction window by expanding or contracting a window start time or window end time in response to a quantified divergence between the short-term interval distribution and the longer-term reference interval distribution; and wherein adjusting the temporal boundary further comprises computing a divergence score by evaluating changes in central tendency and dispersion of the rolling inter-transaction interval series relative to the longer-term reference interval distribution, mapping the divergence score to a window adjustment factor using a predefined scaling function stored in memory, and applying the window adjustment factor to modify the temporal boundary while preserving chronological ordering of transaction events within the transaction window.

In this embodiment, the dynamic construction of transaction windows is realized through a continuously operating temporal adaptation mechanism that is tightly coupled to the observed transaction timing behavior of each monitored entity, thereby eliminating reliance on static or preconfigured window durations. The cloud-based computing system maintains, for each entity, a dedicated state store that persistently holds a time-ordered buffer containing timestamps of the most recent transactions extracted from the structured transaction stream. This buffer is continuously updated as new transaction events arrive, ensuring that only temporally relevant data is retained and that stale historical timing information does not influence current window behavior. Upon receipt of each new transaction event, the system computes a rolling inter-transaction interval series by calculating the differences between successive timestamps in the buffer, thereby capturing the instantaneous pacing and rhythm of transactional activity. From this interval series, a short-term interval distribution is derived, representing the entity's immediate transactional cadence over the most recent activity horizon.

The short-term interval distribution is then systematically compared against a longer-term reference interval distribution that has been previously established for the same entity using historically verified, non-fraudulent transactions. This reference distribution encodes the entity's typical transaction timing behavior under normal conditions, including expected average spacing between transactions and natural variability. By comparing the short-term distribution with the longer-term reference, the system quantifies deviations that may indicate behavioral acceleration, deceleration, or irregular timing patterns. For example, if an entity that normally performs transactions at intervals of several hours suddenly exhibits multiple transactions within seconds or minutes, the divergence between the two distributions becomes significant. In response to such quantified divergence, the system dynamically adjusts the temporal boundary of the active transaction window by either contracting or expanding the window start time or end time, rather than discarding the window or creating a new one. This adjustment ensures that the transaction window remains behaviorally aligned with current activity while still encapsulating a coherent sequence of events.

The adjustment process is further refined by computing a divergence score that jointly evaluates changes in central tendency, such as shifts in mean or median inter-transaction intervals, and changes in dispersion, such as increased variance or spread in the rolling interval series relative to the longer-term reference distribution. This combined assessment prevents overreaction to isolated anomalies and ensures that only sustained or statistically meaningful timing changes influence window boundaries. The divergence score is then mapped to a window adjustment factor using a predefined scaling function stored in memory, which translates the magnitude of behavioral deviation into a proportional temporal modification. This scaling function ensures smooth and bounded window adaptation, preventing abrupt or unstable changes in window size. The resulting adjustment factor is applied to modify the temporal boundary while explicitly preserving the chronological ordering of transaction events within the window, thereby maintaining causal and temporal integrity for downstream fraud analysis.

The technical effect achieved by this process is the creation of transaction windows that elastically adapt to real-time behavioral tempo, enabling early capture of rapid fraud bursts as well as sustained low-frequency anomalies without increasing computational overhead or false positives. The technical advancement lies in the continuous, data-driven temporal self-regulation of transaction windows, which allows the fraud detection system to remain sensitive to subtle timing-based attack patterns while maintaining stability during normal transactional behavior, thereby significantly improving detection efficacy and operational robustness of the present process.

In an embodiment, dynamically constructing the one or more transaction windows further comprises dynamically controlling an event-based boundary by performing the steps of: tracking a cumulative transaction count and cumulative transaction value within each active transaction window; computing a rolling value dispersion metric from transaction amounts within the transaction window; comparing the rolling value dispersion metric to an entity-specific dispersion baseline maintained in the behavioral representations; incrementally increasing an allowable event count threshold when the rolling value dispersion metric remains within a predefined tolerance band; and decrementally reducing the allowable event count threshold when the rolling value dispersion metric exceeds the tolerance band, such that the event-based boundary adapts continuously during window formation.

In this embodiment, the dynamic construction of transaction windows is further enhanced through continuous adaptation of an event-based boundary that regulates how many transaction events may be accumulated within an active window, based not merely on count but on the statistical stability of transaction values. For each active transaction window associated with a monitored entity, the cloud-based computing system persistently tracks both a cumulative transaction count and an aggregated transaction value as transactions are incorporated into the window. These cumulative measures are updated incrementally upon arrival of each new transaction event, allowing the system to maintain an up-to-date quantitative summary of activity within the window without reprocessing historical events.

As transactions accumulate, the system computes a rolling value dispersion metric derived from the distribution of transaction amounts currently contained within the window. This dispersion metric captures the variability and spread of transaction values, such as fluctuations between low-value and high-value amounts, and reflects whether the observed monetary behavior is stable or erratic over the evolving window. The computed rolling dispersion is then compared against an entity-specific dispersion baseline stored within the behavioral representations, where the baseline is derived from historically verified transaction behavior and encodes the normal variability range for that entity's transaction amounts. By grounding the comparison in an entity-specific baseline rather than a global threshold, the system accommodates natural differences in spending behavior across entities while preserving sensitivity to abnormal patterns.

When the rolling value dispersion metric remains within a predefined tolerance band around the entity-specific baseline, the system interprets the transaction behavior as value-consistent and incrementally increases the allowable event count threshold for the active window. This controlled relaxation permits additional transactions to be included within the same window, enabling richer contextual aggregation when behavior remains coherent. Conversely, when the rolling value dispersion metric exceeds the tolerance band, indicating abnormal variability such as sudden spikes or oscillations in transaction amounts, the system decrementally reduces the allowable event count threshold. This tightening causes the window to reach its event-based boundary sooner, prompting earlier risk evaluation and limiting the dilution of anomalous signals by subsequent transactions.

Through this continuous adjustment, the event-based boundary evolves dynamically during window formation rather than being fixed at window initialization. For example, in a scenario where a legitimate user performs multiple transactions of similar value in quick succession, the window naturally expands to include those events, supporting accurate behavioral modeling. In contrast, a fraud scenario involving rapid alternation between probing micro-transactions and large unauthorized charges causes dispersion escalation, resulting in early window closure and accelerated fraud risk computation. The technical effect achieved by this process is a value-aware transaction window that selectively aggregates stable behavior while isolating unstable or suspicious patterns. The technical advancement lies in coupling event count control directly to statistical value dispersion, which improves fraud detection sensitivity, reduces unnecessary window fragmentation, and enhances the overall technical efficacy of the present process by aligning window boundaries with monetary behavior dynamics rather than arbitrary limits.

In an embodiment, generating multiple concurrent transaction windows for the single monitored entity comprises instantiating, in parallel, a plurality of window instances each associated with a distinct temporal sensitivity parameter, storing transaction membership for each window instance in separate window-specific data structures, and independently updating the temporal and event-based boundaries of each window instance based on transaction behavior observed within the respective window instance rather than sharing fixed boundary parameters across the plurality of window instances; and wherein performing fraud risk computation independently for each concurrent transaction window comprises executing, for each window instance, a separate attribute correlation pipeline that retrieves only historical behavioral representations corresponding to the temporal sensitivity parameter of the respective window instance, computes a window-specific fraud risk state, and associates the computed fraud risk state with a window identifier and timestamp prior to any aggregation across window instances.

In this embodiment, the system is configured to simultaneously maintain and evaluate multiple transaction windows for a single monitored entity, each window being optimized to detect transaction behaviors occurring at different temporal scales. Upon receipt of transaction events for the entity, the cloud-based computing system instantiates, in parallel, a plurality of window instances, wherein each window instance is explicitly associated with a distinct temporal sensitivity parameter that defines how rapidly the window responds to changes in transaction behavior. These sensitivity parameters may correspond, for example, to short-horizon windows designed to capture burst-like activity occurring within seconds or minutes, medium-horizon windows intended to observe transactional patterns over typical usage intervals, and long-horizon windows aimed at identifying slow, low-frequency fraud patterns that unfold over extended periods. Each window instance maintains its own window-specific data structure that records transaction membership, current temporal boundaries, event-based thresholds, and intermediate behavioral metrics, thereby ensuring strict isolation of state across window instances.

As transaction events are ingested, each window instance independently updates its temporal and event-based boundaries based solely on the transaction behavior observed within that instance, without inheriting or sharing fixed boundary parameters with other windows. This independence ensures that rapid behavioral changes affecting a short-sensitivity window do not inadvertently distort the evolution of a longer-sensitivity window, and vice versa. For example, a sudden cluster of rapid transactions may cause aggressive contraction of a high-sensitivity window while leaving a low-sensitivity window largely unchanged, preserving its ability to contextualize the activity within a broader behavioral timeline. This parallel and independent boundary evolution enables the system to maintain multiple, behaviorally coherent views of the same transaction stream, each tuned to a different detection objective.

Fraud risk computation is likewise performed independently for each concurrent transaction window through the execution of a separate attribute correlation pipeline associated with that window instance. For each window, the system selectively retrieves only those historical behavioral representations that correspond to the temporal sensitivity parameter of the window, ensuring that short-term windows are compared against short-term historical patterns and long-term windows against long-term behavioral baselines. Transaction attributes within the window are correlated against the retrieved historical representations to compute a window-specific fraud risk state that reflects anomalies observable at that particular temporal resolution. The resulting fraud risk state is then explicitly associated with a unique window identifier and a timestamp corresponding to the evaluation moment, creating a traceable and temporally anchored risk record for each window instance prior to any cross-window aggregation or decision-making.

The technical effect achieved by this embodiment is the simultaneous detection of heterogeneous fraud behaviors that manifest at different temporal speeds, without sacrificing analytical precision or introducing cross-scale interference. The technical advancement lies in the parallel, sensitivity-aware window instantiation and isolated risk computation pipelines, which allow the present process to uncover rapid attack bursts, gradual account takeovers, and intermittent probing behaviors within a unified system. This multi-resolution analysis significantly enhances fraud detection efficacy while maintaining deterministic state management and scalable execution within the cloud-based computing environment.

In an embodiment, correlating transaction attributes contained within each dynamically constructed transaction window with historical behavioral representations comprises transforming raw transaction attributes into normalized attribute vectors using entity-specific normalization parameters, partitioning the normalized attribute vectors into contextual attribute groups corresponding to transaction channel context, device context, and geographic context, and performing correlation operations independently for each contextual attribute group against corresponding segments of the historical behavioral representations; and wherein retrieving the adaptive behavioral baselines comprises selecting, from a plurality of stored baseline versions associated with the monitored entity, a baseline version corresponding to a current behavioral phase of the monitored entity determined from previously verified transaction outcomes, and excluding baseline versions associated with behavioral phases identified as anomalous or fraudulent.

In this embodiment, the correlation of transaction attributes with historical behavioral representations is implemented through a structured, context-aware transformation and comparison process that ensures meaningful and behaviorally aligned analysis. As transaction events are accumulated within a dynamically constructed transaction window, the system first converts the raw transaction attributes into normalized attribute vectors using normalization parameters that are specific to the monitored entity. These parameters are derived from historically verified transactions and account for entity-specific ranges, frequencies, and value distributions, thereby removing scale bias and preventing disproportionate influence of attributes that naturally exhibit higher numeric magnitude or variability. As a result, attributes such as transaction amount, transaction frequency, device identifier stability, and location change frequency are represented on a comparable scale that accurately reflects deviation from the entity's own historical norms rather than from a global average.

Once normalized, the attribute vectors are logically partitioned into distinct contextual attribute groups corresponding to transaction channel context, device context, and geographic context. The transaction channel context group encapsulates attributes related to how the transaction is initiated, such as online versus in-store usage, payment interface, or authentication method. The device context group aggregates attributes describing the device or endpoint characteristics, including device fingerprint stability and operating environment consistency. The geographic context group captures location-related attributes such as transaction origin, region transitions, and distance from prior transaction locations. Correlation operations are then performed independently for each contextual attribute group against corresponding segments of the historical behavioral representations, rather than correlating all attributes in aggregate. This independent correlation allows the system to identify context-specific anomalies, such as a legitimate channel change accompanied by an anomalous device signature, without conflating unrelated behavioral signals. For example, a customer traveling abroad may show geographic deviations that are normal for travel but still maintain stable device and channel characteristics, which the system can correctly interpret as low-risk behavior.

Retrieval of adaptive behavioral baselines is further refined by maintaining multiple baseline versions for each monitored entity, where each baseline version corresponds to a distinct behavioral phase inferred from previously verified transaction outcomes. These behavioral phases may represent normal domestic usage, travel-related activity, seasonal spending patterns, or other recurring behavioral modes. When evaluating a transaction window, the system selects the baseline version that best corresponds to the entity's current behavioral phase, as determined by alignment between recent transaction attributes and historically validated patterns. Baseline versions associated with behavioral phases that have been identified as anomalous or fraudulent are explicitly excluded from selection, preventing contaminated data from influencing current correlation results. For instance, if a past account compromise was verified, the behavioral patterns observed during that period are retained only for forensic purposes and are not reused as reference baselines.

The technical effect achieved by this embodiment is highly precise, context-sensitive correlation that reduces false positives caused by legitimate contextual shifts while preserving sensitivity to genuine anomalies. The technical advancement lies in the combination of entity-specific normalization, contextual attribute partitioning, and phase-aware baseline selection, which together ensure that transaction evaluation is grounded in relevant, verified behavioral history. This significantly improves the technical efficacy of the present process by enabling accurate fraud risk assessment even under dynamic and evolving transaction contexts.

In an embodiment, computing the fraud risk state for each dynamically constructed transaction window comprises generating a plurality of intermediate risk indicators corresponding to different transaction attribute relationships observed within the transaction window, temporally aligning the intermediate risk indicators based on transaction occurrence times, and combining the temporally aligned intermediate risk indicators into the fraud risk state using an aggregation sequence that preserves contribution order of transaction events within the transaction window.

In this embodiment, the computation of the fraud risk state is performed through a temporally structured and relationship-aware evaluation process that incrementally builds risk understanding as transaction events unfold within a dynamically constructed transaction window. As transactions are incorporated into the window, the cloud-based computing system generates a plurality of intermediate risk indicators, each indicator representing a quantified assessment of a specific relationship between transaction attributes observed within the window. These relationships may include, for example, deviations between transaction amount and historical spending patterns, inconsistencies between device characteristics and transaction channel, abnormal geographic transitions relative to prior locations, or unusual sequencing of authentication methods. Each intermediate risk indicator is computed in relation to one or more transaction events and is associated with explicit timing information reflecting when the contributing transaction occurred.

The intermediate risk indicators are then temporally aligned based on transaction occurrence times to ensure that the relative ordering and spacing of contributing events are preserved. This alignment step ensures that indicators derived from earlier transactions influence the evolving risk state before those derived from later transactions, thereby maintaining the causal and chronological structure of the transaction sequence. For instance, a device change occurring prior to a high-value transaction is treated differently from a device change that follows the transaction, as the former may indicate preparatory fraud behavior while the latter may be benign. By anchoring each indicator to its corresponding transaction timestamp, the system avoids collapsing temporally distinct signals into an unordered aggregate that could obscure meaningful behavioral progression.

Once aligned, the intermediate risk indicators are combined into the fraud risk state using an aggregation sequence that explicitly preserves the contribution order of transaction events within the transaction window. The aggregation process incrementally updates the fraud risk state as each new transaction and its associated indicators are processed, allowing earlier anomalies to condition the interpretation of subsequent behavior rather than being averaged out. For example, an initial low-severity anomaly may increase the sensitivity of the aggregation logic, causing later moderate deviations to have a greater cumulative impact on the final risk state. This ordered aggregation ensures that the fraud risk state reflects not only the presence of anomalous attributes but also the sequence in which they occur.

The technical effect achieved by this embodiment is a fraud risk state that faithfully represents the temporal evolution of transaction behavior, enabling the detection of multi-step fraud patterns that rely on ordered actions rather than isolated events. The technical advancement lies in the preservation of temporal contribution order during risk aggregation, which allows the present process to capture escalation dynamics and behavioral intent more accurately than unordered or stateless scoring methods. As a result, the system achieves higher detection efficacy for complex fraud scenarios while maintaining interpretability and robustness in risk computation.

In an embodiment, assigning context-dependent weights to transaction attributes comprises computing, for each transaction attribute, a context relevance score derived from historical frequency of attribute variation within the same transaction channel, device characteristics, and geographic indicators, updating the context relevance score over time based on feedback from previously verified transaction outcomes, and applying the updated context relevance score as a dynamic weighting factor during fraud risk state computation; and wherein dynamically adjusting the fraud decision threshold comprises maintaining a rolling sequence of fraud risk states computed across successive transaction windows for the monitored entity, calculating a trend indicator representing directional change in fraud risk across the rolling sequence, and modifying the fraud decision threshold incrementally in response to the trend indicator while enforcing predefined upper and lower threshold bounds stored in the cloud-based computing system.

In this embodiment, the assignment of context-dependent weights to transaction attributes is implemented through a continuously learning relevance assessment mechanism that adapts attribute influence based on contextual behavior patterns observed over time. For each transaction attribute evaluated during fraud risk computation, the cloud-based computing system computes a context relevance score that reflects how meaningfully variations in that attribute correlate with verified transaction outcomes within comparable contexts. This relevance score is derived by analyzing the historical frequency and magnitude of attribute variation within the same transaction channel, under similar device characteristics, and across comparable geographic indicators. Attributes that frequently vary under legitimate conditions within a given context, such as minor location changes for mobile transactions, are assigned lower relevance scores, while attributes that typically remain stable, such as device identifiers or authentication methods, are assigned higher relevance scores when they deviate. This ensures that attribute influence is grounded in contextual behavioral expectations rather than static assumptions.

The context relevance score is not fixed but is updated over time based on feedback obtained from previously verified transaction outcomes, including confirmed legitimate transactions and confirmed fraud events. As the system observes which attribute deviations consistently precede fraudulent outcomes within specific contexts, it incrementally adjusts the relevance scores to reflect empirical evidence. For example, if device characteristic changes within a particular channel are repeatedly associated with fraud confirmations, the relevance score for those attributes in that context is increased, thereby amplifying their contribution in future risk computations. The updated context relevance score is then applied as a dynamic weighting factor during fraud risk state computation, modulating the impact of each attribute's deviation on the intermediate and aggregated risk indicators. This adaptive weighting mechanism allows the system to remain responsive to evolving fraud strategies without requiring manual reconfiguration.

In parallel, dynamic adjustment of the fraud decision threshold is performed by maintaining a rolling sequence of fraud risk states computed across successive transaction windows for the monitored entity. This sequence captures the temporal progression of risk rather than isolated snapshots. From this rolling sequence, the system calculates a trend indicator that represents the directional change in fraud risk over time, such as a steadily increasing, decreasing, or oscillating pattern. When the trend indicator reflects a sustained increase in risk across multiple windows, the system incrementally tightens the fraud decision threshold, making it more sensitive to emerging threats. Conversely, when the trend indicates stable or decreasing risk, the threshold may be cautiously relaxed to reduce unnecessary intervention. All threshold adjustments are constrained within predefined upper and lower bounds stored in the cloud-based computing system, ensuring decision stability and preventing abrupt or excessive threshold shifts.

In an embodiment, distributing the dynamically constructed transaction windows across the plurality of processing nodes comprises partitioning transaction windows based on entity identifiers, assigning each partition to a processing node together with the corresponding entity-specific state store, and synchronizing updates to transaction window boundaries using versioned state updates propagated across the plurality of processing nodes to prevent divergence in transaction window construction during parallel execution; and wherein replicating transaction window state information comprises periodically checkpointing, for each transaction window, a snapshot including window boundaries, transaction membership, and intermediate fraud risk indicators, storing the snapshot in at least two geographically distinct storage locations, and restoring the snapshot on reassignment of a transaction window to a different processing node following a detected processing node failure.

In this embodiment, the scalable and fault-tolerant execution of dynamic transaction window construction is achieved through a coordinated distribution and replication strategy that preserves analytical consistency while enabling parallel processing across a cloud-based computing environment. Transaction windows are first partitioned based on entity identifiers, ensuring that all windows and associated transaction activity for a given monitored entity are consistently handled within the same logical partition. Each partition is then assigned to a specific processing node along with the corresponding entity-specific state store, which contains all window-related metadata, behavioral metrics, and adaptive boundary parameters required for incremental window evolution. By colocating transaction windows with their state stores, the system minimizes cross-node communication latency and ensures deterministic window updates during high-throughput transaction ingestion.

As multiple processing nodes operate concurrently, updates to transaction window boundaries are synchronized using versioned state updates that are propagated across the plurality of processing nodes. Each update to a window's temporal or event-based boundary is tagged with a version identifier, allowing receiving nodes to apply updates in the correct order and to detect and discard stale or conflicting updates. This versioning mechanism prevents divergence in transaction window construction that could otherwise arise from parallel execution, delayed message delivery, or transient network inconsistencies. For example, if a transaction window is temporarily reassigned or mirrored for load balancing, the versioned updates ensure that only the most recent and authoritative window state is retained, preserving consistency of transaction membership and boundary alignment across the system.

In addition to synchronized execution, the system implements robust state replication by periodically checkpointing the state of each transaction window. Each checkpoint snapshot encapsulates the complete window state at a given moment, including current temporal boundaries, indices of transactions included within the window, and intermediate fraud risk indicators accumulated thus far. These snapshots are stored redundantly in at least two geographically distinct storage locations, providing resilience against localized failures, network partitions, or data center outages. When a processing node failure is detected and a transaction window is reassigned to a different node, the most recent consistent snapshot is retrieved and restored, allowing window construction and fraud risk computation to resume from the last known state without reprocessing historical transactions.

In an embodiment, normalizing and serializing the received transaction events into the structured transaction stream comprises extracting heterogeneous transaction fields originating from different transaction sources, converting the extracted fields into a common canonical representation using source-specific transformation rules stored in the cloud-based computing system, assigning a monotonically increasing sequence identifier to each normalized transaction event, and serializing the normalized transaction events into a time-ordered stream while preserving original transaction arrival order across distributed sources; and wherein dynamically constructing the one or more transaction windows further comprises maintaining, for each monitored entity, a mutable window state object comprising current window boundaries, transaction membership indices, and window-specific behavioral metrics, updating the mutable window state object incrementally upon arrival of each new transaction event, and recalculating the window boundaries without reprocessing previously ingested transaction events.

In this embodiment, the formation of a structured transaction stream is achieved through a normalization and serialization process that unifies heterogeneous transaction inputs into a consistent, order-preserving data flow suitable for real-time window construction and analysis. Transaction events originating from different transaction sources, such as point-of-sale systems, online payment gateways, mobile applications, or third-party processors, often contain disparate field formats, naming conventions, and encoding schemes. The cloud-based computing system extracts these heterogeneous transaction fields and converts them into a common canonical representation by applying source-specific transformation rules stored in memory. These transformation rules define how each source's native fields are mapped, scaled, and encoded into standardized attributes, ensuring semantic equivalence across sources while preserving the original informational content. As a result, downstream processing operates on uniform transaction structures regardless of source diversity.

Following normalization, each transaction event is assigned a monotonically increasing sequence identifier that reflects its relative arrival order within the system. This sequence identifier is generated independently of the transaction source and ensures that transaction events can be deterministically ordered even when they are received asynchronously from distributed sources. The normalized transaction events are then serialized into a time-ordered stream that preserves the original transaction arrival order across all sources, preventing reordering artifacts that could otherwise distort behavioral analysis. For example, transactions initiated nearly simultaneously from different channels are serialized in a consistent sequence, enabling accurate reconstruction of behavioral timelines during window formation and risk computation.

Dynamic construction of transaction windows is further supported by maintaining, for each monitored entity, a mutable window state object that encapsulates all information required for incremental window evolution. This window state object includes current temporal and event-based boundaries, indices identifying which serialized transactions belong to the window, and window-specific behavioral metrics such as cumulative counts, value dispersion measures, and intermediate risk indicators. Upon arrival of each new transaction event, the system updates the mutable window state object incrementally by appending the transaction index, refreshing behavioral metrics, and adjusting boundaries as dictated by adaptive window logic. Crucially, window boundary recalculation is performed without reprocessing previously ingested transaction events, as all necessary historical context is already captured within the window state object.

In an embodiment, adjusting the transaction window overlap parameter comprises determining an overlap ratio between successive transaction windows based on a measured rate of change in transaction behavior, increasing the overlap ratio when successive transaction windows exhibit rapid changes in transaction attributes, and decreasing the overlap ratio when successive transaction windows exhibit stable transaction behavior, such that overlapping windows selectively share transaction events during periods of behavioral instability; and wherein correlating transaction attributes with historical behavioral representations further comprises aligning transaction attributes within the dynamically constructed transaction window to corresponding temporal segments of the historical behavioral representations, compensating for differences in transaction density by resampling historical behavioral data to match a temporal granularity of the transaction window, and performing correlation using the temporally aligned data rather than raw historical records.

In this embodiment, the adjustment of the transaction window overlap parameter is governed by a behavior-driven control mechanism that dynamically regulates how much contextual information is shared between successive transaction windows. Rather than applying a fixed overlap, the cloud-based computing system continuously measures the rate of change in transaction behavior across adjacent windows by evaluating variations in key transaction attributes such as transaction frequency, value dispersion, device consistency, and geographic movement. When this measured rate of change exceeds a predefined stability threshold, indicating rapid or volatile behavioral shifts, the system increases the overlap ratio between successive transaction windows. This increased overlap causes a selective sharing of transaction events across windows, ensuring that transitional or evolving behaviors are captured with sufficient contextual continuity. For example, during an account takeover attempt where transaction attributes change progressively rather than abruptly, overlapping windows allow early anomalous signals to influence subsequent window evaluations, improving detection sensitivity.

Conversely, when successive transaction windows exhibit stable transaction behavior characterized by minimal attribute variation and consistent behavioral metrics, the system decreases the overlap ratio to reduce redundancy and computational overhead. In such stable periods, windows are allowed to share fewer or no transaction events, as behavioral continuity can be reliably inferred without explicit overlap. This adaptive overlap adjustment ensures that computational resources are concentrated during periods of behavioral instability while maintaining efficiency during normal operation. The technical effect achieved is a transaction windowing strategy that dynamically balances contextual continuity and processing efficiency based on real-time behavioral volatility.

In addition, correlation of transaction attributes with historical behavioral representations is refined through temporal alignment and density compensation to ensure meaningful comparisons across varying activity levels. Transaction attributes within a dynamically constructed transaction window are aligned to corresponding temporal segments of the historical behavioral representations, ensuring that comparisons are made between behavior observed over comparable time horizons. When differences in transaction density exist, such as comparing a high-frequency burst of recent transactions to a historically sparse activity period, the system compensates by resampling the historical behavioral data to match the temporal granularity of the transaction window. This resampling may involve interpolation or aggregation of historical data points so that both datasets represent behavior at equivalent temporal resolution.

Correlation is then performed using the temporally aligned and density-adjusted data rather than raw historical records, preventing skew caused by mismatched sampling rates or activity intensities. For instance, a short, high-density transaction window is not incorrectly flagged as anomalous simply because historical data was collected at a coarser temporal resolution. The technical advancement lies in combining adaptive window overlap with temporally normalized correlation, enabling the present process to accurately detect behavioral transitions while maintaining robustness across varying transaction rates. This significantly enhances the technical efficacy of fraud detection by ensuring continuity during instability and precision during stable transaction behavior.

In an embodiment, retrieving the adaptive behavioral baselines comprises maintaining multiple baseline states for the monitored entity corresponding to different transaction contexts, selecting a baseline state based on a dominant transaction context inferred from the transaction attributes within the transaction window, and excluding baseline states associated with transaction contexts not present within the transaction window.

In this embodiment, the retrieval of adaptive behavioral baselines is implemented through a context-aware baseline management process that recognizes that a monitored entity may legitimately exhibit multiple, distinct transaction behaviors depending on situational context. The cloud-based computing system maintains, for each monitored entity, a plurality of baseline states, where each baseline state corresponds to a different transaction context derived from historically verified transaction activity. These transaction contexts may represent, for example, in-store versus online usage, domestic versus international transactions, mobile versus desktop device interaction, or routine low-value spending versus periodic high-value purchases. Each baseline state encapsulates statistical and behavioral descriptors such as typical transaction frequency, value dispersion, device stability, and geographic transition patterns specific to that context.

When a dynamically constructed transaction window is evaluated, the system infers a dominant transaction context by analyzing the attributes of the transactions contained within the window. This inference is performed by determining which contextual indicators occur most consistently or contribute most significantly across the window, such as repeated use of a particular channel, consistent device characteristics, or a coherent geographic pattern. Based on this dominant context, the system selects the corresponding baseline state that most accurately reflects the entity's expected behavior under those conditions. For instance, if the majority of transactions within the window are online and originate from a consistent mobile device, the system selects the baseline state associated with online mobile usage rather than a baseline associated with in-store transactions.

Baseline states associated with transaction contexts that are not present within the transaction window are explicitly excluded from consideration. This exclusion prevents irrelevant or mismatched behavioral patterns from influencing fraud risk assessment, such as comparing online transactions against a baseline derived from physical point-of-sale activity. By restricting baseline selection to contextually aligned states, the system avoids false deviations caused by legitimate context shifts and ensures that comparisons are behaviorally meaningful.

In an embodiment, computing the fraud risk state for each dynamically constructed transaction window further comprises generating intermediate attribute deviation values by comparing transaction attributes within the transaction window to corresponding attributes in the selected adaptive behavioral baseline, aggregating the intermediate attribute deviation values over a progression of transaction events within the window, and updating the fraud risk state incrementally as additional transaction events are incorporated into the transaction window.

In this embodiment, the computation of the fraud risk state is extended through an incremental deviation-based evaluation process that continuously refines risk assessment as transaction events accumulate within a dynamically constructed transaction window. For each transaction incorporated into the window, the cloud-based computing system generates intermediate attribute deviation values by comparing the observed transaction attributes against corresponding attributes defined in the selected adaptive behavioral baseline that has been contextually matched to the monitored entity. These deviation values quantify the degree to which each attribute departs from expected behavior, taking into account entity-specific norms such as typical transaction amounts, usual device characteristics, expected transaction timing, and common geographic patterns. By grounding deviation computation in a context-appropriate baseline, the system ensures that deviations reflect meaningful anomalies rather than benign behavioral variation.

As the transaction window evolves, the intermediate attribute deviation values are aggregated over the progression of transaction events within the window rather than being evaluated in isolation. This aggregation preserves the temporal sequence of events and allows the system to observe how deviations accumulate, escalate, or dissipate over time. For example, a single moderate deviation in transaction amount may be treated as low risk if followed by transactions that conform to baseline behavior, whereas a sequence of increasingly severe deviations across successive transactions results in a progressively elevated risk signal. The aggregation logic is designed to weight recent deviations appropriately while still considering earlier deviations as contextual precursors, thereby capturing behavioral trends rather than isolated outliers.

The fraud risk state is updated incrementally as each additional transaction event is incorporated into the transaction window, allowing the system to refine its risk assessment in real time without recomputing the entire window history. Each update adjusts the current fraud risk state based on the newly aggregated deviation values, enabling early detection of emerging fraud patterns while still accommodating legitimate behavioral corrections. For instance, an initially anomalous transaction followed by rapid normalization may cause the risk state to stabilize or decrease, whereas sustained deviation leads to continuous risk escalation.

In an embodiment, assigning the context-dependent weights to transaction attributes comprises computing a channel-specific relevance profile for each transaction channel using historical transaction outcomes, computing a device-specific stability profile using observed consistency of device characteristics over time, computing a geographic variability profile using historical location change frequency, and combining the relevance profile, stability profile, and variability profile to derive the context-dependent weights applied during fraud risk computation; and wherein dynamically adjusting the fraud decision threshold further comprises storing a threshold adjustment history associated with the monitored entity, limiting a rate of threshold change based on the threshold adjustment history to prevent abrupt threshold shifts, and applying the adjusted fraud decision threshold only after a minimum number of successive transaction windows exhibit a consistent fraud risk trend.

In this embodiment, the assignment of context-dependent weights to transaction attributes is implemented through a multi-profile relevance modeling process that explicitly captures how different behavioral dimensions contribute to fraud risk under varying operational contexts. For each transaction channel associated with the monitored entity, the cloud-based computing system computes a channel-specific relevance profile by analyzing historical transaction outcomes and determining how strongly variations in channel-related attributes correlate with verified fraud or legitimate activity. Channels that historically exhibit higher fraud susceptibility, such as remote or card-not-present transactions, are assigned higher relevance scores for channel-related attributes, while channels with lower historical risk receive proportionally lower influence during fraud risk computation.

In parallel, the system computes a device-specific stability profile by observing the consistency of device characteristics over time for the monitored entity. This profile quantifies how frequently device identifiers, device fingerprints, or operating environment attributes change during legitimate usage. Attributes that are typically stable but suddenly change are assigned higher weight, whereas attributes that naturally fluctuate, such as network-related parameters, are assigned lower weight. Similarly, a geographic variability profile is computed using historical location change frequency, capturing how often the entity transitions between geographic regions under normal conditions. Anomalous geographic shifts that exceed expected variability contribute more heavily to risk when the geographic variability profile indicates that such changes are rare for the entity.

The channel-specific relevance profile, device-specific stability profile, and geographic variability profile are then combined to derive the context-dependent weights applied during fraud risk computation. This combination ensures that attribute influence reflects a holistic understanding of context, allowing the system to emphasize attributes that are both contextually relevant and behaviorally anomalous. For example, a device change occurring in a high-risk channel and in an unexpected location is weighted more heavily than the same device change occurring in a low-risk channel or within a historically variable geographic region. The technical effect achieved is a finely tuned weighting mechanism that adapts attribute influence to real-world behavioral context rather than relying on static or uniform weights.

Dynamic adjustment of the fraud decision threshold is further stabilized through the use of a threshold adjustment history associated with the monitored entity. The system records prior threshold changes and uses this history to limit the rate at which the threshold can be modified, preventing abrupt shifts that could lead to oscillatory or inconsistent decision outcomes. Threshold adjustments are only applied after a minimum number of successive transaction windows exhibit a consistent fraud risk trend, such as a sustained increase or decrease in risk. This requirement ensures that decisions are based on persistent behavioral signals rather than transient anomalies. The technical advancement lies in combining multi-dimensional context-aware weighting with controlled, history-informed threshold adaptation. The technical effect is a fraud decision process that is both sensitive to genuine risk escalation and robust against noise, significantly enhancing the technical efficacy of the present process by aligning detection sensitivity with contextual relevance and temporal consistency.

In an embodiment, generating the transaction control decision further comprises producing a conditional verification decision by identifying a subset of transaction attributes contributing most significantly to the computed fraud risk state, selecting one or more verification actions corresponding to the identified subset of transaction attributes, and associating the selected verification actions with the corresponding transaction prior to issuing the transaction control decision; and wherein evaluating transaction attribute relationships across dynamically evolving transaction windows comprises maintaining a cross-window relationship map that tracks attribute correlations across overlapping transaction windows, updating the cross-window relationship map as window boundaries change, and incorporating the tracked cross-window attribute correlations into the fraud risk state computation in addition to correlations observed within a single transaction window.

In this embodiment, the generation of the transaction control decision is extended beyond binary approval or rejection by introducing a conditional verification mechanism that is directly informed by the underlying drivers of fraud risk. After the fraud risk state has been computed for a dynamically constructed transaction window, the cloud-based computing system analyzes the contribution of individual transaction attributes and attribute relationships to the overall risk state. This analysis identifies a subset of transaction attributes that have contributed most significantly to risk elevation, such as anomalous device characteristics, unusual geographic transitions, atypical transaction amounts, or irregular channel usage patterns. By isolating the specific attributes responsible for risk escalation, the system avoids indiscriminate verification actions and instead tailors verification to the detected anomaly.

Based on the identified subset of high-impact attributes, the system selects one or more verification actions that are directly relevant to validating those attributes. For example, if device-related attributes dominate the risk contribution, the system may select a device re-authentication or device binding verification action; if geographic inconsistency is the primary contributor, an out-of-band location confirmation may be selected; and if transaction amount deviation is dominant, step-up financial verification may be applied. These selected verification actions are then explicitly associated with the corresponding transaction before the transaction control decision is issued, ensuring that any conditional approval is accompanied by targeted verification requirements. The technical effect achieved is a proportional and explainable control decision that minimizes user friction while maintaining strong fraud mitigation.

In parallel, evaluation of transaction attribute relationships is enhanced through maintenance of a cross-window relationship map that persists beyond individual transaction windows. This map tracks how specific transaction attributes and attribute combinations correlate across overlapping and successive transaction windows, capturing behavioral dependencies that unfold over time. As transaction window boundaries dynamically expand, contract, or overlap, the cross-window relationship map is updated to reflect new correlations and to decay obsolete ones. This enables the system to recognize patterns such as recurring device changes followed by geographic anomalies across multiple windows, which may not appear sufficiently anomalous within any single window alone.

The tracked cross-window attribute correlations are incorporated into the fraud risk state computation in addition to correlations observed within the current transaction window. By integrating cross-window relationships, the system accounts for longitudinal behavioral patterns and escalation strategies employed by sophisticated fraud attempts. The technical advancement lies in combining targeted, attribute-driven conditional verification with longitudinal correlation analysis across evolving windows. The technical effect is a more precise, adaptive, and context-aware transaction control process that significantly enhances the technical efficacy of the present process by improving fraud detection accuracy while reducing unnecessary transaction disruption.

In operation, electronic transaction events are continuously received from one or more transaction sources such as payment gateways, banking systems, merchant interfaces, or digital service authorization points. Each incoming transaction event is first processed by the transaction ingestion unit, which performs normalization by transforming heterogeneous transaction formats into a unified internal representation. This representation includes standardized temporal markers, monetary values, entity identifiers, channel indicators, device-related attributes, and contextual metadata. The normalized transaction events are serialized into a structured transaction stream that preserves event ordering information while allowing subsequent correction for out-of-order arrivals. This ingestion step ensures that downstream processing units operate on a consistent and machine-interpretable transaction sequence.

Following ingestion, the structured transaction stream is supplied to the dynamic transaction window management unit, which maintains a set of active transaction windows for each monitored entity. A monitored entity may correspond to an account, user identifier, payment instrument, device identifier, merchant identifier, or any other entity for which transaction behavior is evaluated. For each entity, the technique initializes a transaction window with default boundary parameters derived from an initial behavioral baseline or a system-defined starting configuration. As transaction events accumulate, the technique continuously evaluates transaction frequency, inter-event timing, transaction amount variability, and contextual consistency within the active window.

The technique dynamically adjusts the transaction window boundaries in response to observed behavior. When transaction frequency increases beyond an expected range or when inter-transaction timing becomes irregular, the technique expands the temporal or event-based extent of the window to capture a broader sequence of related transactions. Conversely, when transaction behavior stabilizes and conforms to stored behavioral baselines within a tolerance range, the technique contracts the window boundaries to reduce unnecessary aggregation. In certain risk conditions, the technique instantiates multiple concurrent transaction windows for the same entity, each operating at a different temporal resolution, thereby enabling parallel evaluation of short-term bursts and long-term behavioral drift.

As transaction windows evolve, the technique continuously correlates transaction attributes within each window against historical behavioral representations retrieved from the behavioral baseline storage unit. These behavioral representations encode typical transaction rhythms, value ranges, channel usage patterns, and contextual characteristics associated with the monitored entity. The technique does not rely on static thresholds but instead evaluates deviations relative to the adaptive baseline, allowing the system to accommodate legitimate behavioral changes while remaining sensitive to anomalous patterns. Behavioral baselines are stored as evolving data structures that are updated incrementally based on verified transaction outcomes and confirmed fraud determinations.

For each dynamically constructed transaction window, the fraud risk analysis unit executes a risk computation technique that aggregates evidence across the window. The technique evaluates attribute correlations such as changes in transaction velocity, clustering of transaction amounts, shifts in geographic indicators, and inconsistencies between historical and current device or channel usage. Contextual weighting is applied to transaction attributes based on the current transaction context, allowing the technique to emphasize or de-emphasize specific signals depending on channel, entity type, or environmental conditions. The output of this computation is a fraud risk state associated with the transaction window, which reflects both instantaneous anomalies and cumulative behavioral evidence.

The technique further tracks sequences of fraud risk states across successive transaction windows associated with the same monitored entity. By analyzing trends in these risk states, the system detects gradual behavioral drift that may indicate low-intensity or slowly evolving fraud. When such drift is detected, the technique may preemptively expand transaction windows or adjust risk sensitivity parameters to capture additional evidence before a final decision is rendered. This temporal accumulation of risk information enables the system to move beyond single-event scoring and instead reason over evolving transaction behavior.

Once a fraud risk state is computed, the fraud decision unit evaluates the risk state against dynamically adjusted decision thresholds. These thresholds are not fixed but are recalibrated based on recent risk trends, system-wide fraud conditions, and entity-specific behavior. If the risk state falls below a lower threshold, the technique generates an approval decision and allows the transaction to proceed without interruption. If the risk state exceeds an upper threshold, the technique generates a rejection decision or a fraud alert. For intermediate risk states, the technique generates a conditional verification decision that triggers additional authentication or verification steps before final authorization.

Throughout this process, the cloud orchestration unit coordinates distribution of transaction windows and risk computations across multiple processing nodes within the cloud computing environment. The technique assigns transaction windows to processing nodes based on window complexity, transaction density, and current processing load, ensuring efficient utilization of computational resources. Transaction window state information is replicated across storage locations to maintain continuity of fraud analysis in the event of processing node failure or reassignment. This state replication ensures that dynamic window evolution and risk accumulation are not disrupted by infrastructure-level events.

The technique also includes handling of out-of-order and late-arriving transaction events. When such events are detected, the transaction ingestion unit corrects temporal alignment and reassigns the events to the appropriate dynamic transaction windows. The window management technique then recalculates affected correlations and risk states to ensure that fraud decisions reflect the complete and accurate transaction sequence.

Finally, the technique incorporates a feedback loop in which confirmed transaction outcomes, including verified fraud cases and confirmed legitimate transactions, are fed back into the behavioral baseline storage unit. This feedback enables continuous refinement of baseline representations and risk computation parameters, allowing the system to adapt over time to changing user behavior, emerging fraud strategies, and evolving transaction ecosystems. Through this adaptive technique operation, the invention achieves accurate, scalable, and context-aware fraud detection in cloud-based transaction processing environments while maintaining low latency and high reliability.

In accordance with the present invention, an adaptive cloud-based fraud detection system is disclosed, wherein the system operates as a distributed computing environment deployed across one or more cloud infrastructures. The system receives transaction data streams originating from transaction sources including financial institutions, payment gateways, merchant systems, digital wallets, or service authorization platforms. Each transaction event comprises transactional attributes including monetary value, transaction timestamp, origin and destination identifiers, device identifiers, location indicators, transaction channel metadata, and historical reference markers.

Upon ingestion, the transaction events are routed to a transaction ingestion interface that normalizes and serializes the incoming data into a structured transaction stream. The structured stream is forwarded to a dynamic transaction window management unit configured to construct transaction windows that are adaptive in size, duration, and composition. Unlike fixed windows, the dynamic transaction windows are parameterized based on continuously evaluated behavioral metrics, transaction velocity, temporal irregularities, and contextual deviation scores. For each entity under observation, including users, accounts, devices, or merchants, the system maintains one or more active transaction windows whose boundaries evolve in response to observed transaction behavior.

The dynamic transaction window management unit continuously evaluates transaction density, inter-arrival time variance, transaction amount dispersion, and contextual consistency. When anomalous acceleration, deceleration, or behavioral drift is detected, the system automatically expands or contracts the transaction window to capture a relevant transaction sequence for risk evaluation. In high-risk scenarios, the system generates overlapping or nested windows to perform parallel fraud analysis at multiple temporal granularities. In low-risk scenarios, the window scope is reduced to conserve computational resources while preserving monitoring continuity.

Transaction windows generated by the system are forwarded to a fraud risk analysis unit operating within the cloud environment. The fraud risk analysis unit computes composite risk scores for each window by correlating transaction attributes with historical behavioral baselines, contextual intelligence, and adaptive risk thresholds. The system continuously updates baseline behavior models by learning from verified outcomes and feedback loops, thereby enabling long-term behavioral adaptation without static configuration. Risk scores are recalibrated dynamically as window boundaries shift, ensuring that fraud decisions reflect the most contextually relevant transaction sequences.

The system further includes a fraud decision and response unit that evaluates computed risk scores against adaptive decision thresholds. Based on the evaluated risk state, the system generates fraud-related actions including transaction approval, rejection, delayed authorization, step-up authentication requests, or alert notifications. The decision logic is executed in real time and is capable of issuing responses within the transaction processing latency constraints of the underlying financial or service platform.

The cloud-based architecture of the system enables horizontal scalability by distributing transaction windows and risk computations across multiple processing nodes. Load balancing mechanisms dynamically allocate transaction windows to processing units based on window complexity, transaction volume, and system resource availability. The system also supports fault tolerance by replicating window state data across cloud storage units, ensuring continuity of fraud monitoring even during partial system failures.

In an embodiment of the invention, a specialized fraud detection computing device is provided, wherein the device is configured as a machine structure deployable within a cloud data center or private infrastructure. The device comprises a processing unit implemented as one or more multi-core processors configured to execute adaptive transaction window management instructions. The processing unit is operatively coupled to a memory unit that stores executable instructions, behavioral profiles, dynamic window parameters, and historical transaction representations. The memory unit further maintains transient window states and risk computation buffers required for real-time analysis.

The device includes a communication interface configured to establish secure data communication channels with external transaction sources and distributed cloud nodes. The communication interface supports high-throughput streaming protocols to enable continuous ingestion and dissemination of transaction data and fraud decisions. A storage interface is provided for persistent storage of transaction histories, behavioral baselines, and adaptive model states within cloud storage systems.

The internal architecture of the device includes a transaction window controller configured to dynamically adjust window parameters in response to real-time input signals and risk feedback. The controller interacts with the processing unit to orchestrate window expansion, contraction, merging, and segmentation operations. A fraud inference controller coordinates execution of risk computation logic across distributed processing units and synchronizes fraud decisions with external transaction systems.

The device is further structured to support cloud orchestration mechanisms that allow instantiation, scaling, and termination of fraud detection instances based on transaction load and risk density. The machine structure thereby enables efficient execution of adaptive fraud detection logic while maintaining low latency, high availability, and elastic scalability.

In operation, the method of adaptive cloud-based fraud detection begins with receiving transaction data streams from one or more transaction sources. The method includes dynamically constructing transaction windows for each monitored entity, wherein the transaction windows are continuously adjusted based on observed transaction behavior and contextual signals. The method further includes computing fraud risk scores for each dynamic transaction window using adaptive behavioral baselines and real-time transaction correlations. Based on the computed risk scores, the method generates fraud-related decisions and responses, which are communicated back to transaction processing systems in real time. The method further includes updating behavioral baselines and window adjustment parameters based on confirmed transaction outcomes, thereby enabling continuous system adaptation.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method for adaptive cloud-based fraud detection using dynamic transaction windows, comprising the steps of:
receiving, by a transaction ingestion unit executing on a cloud-based computing system, electronic transaction events originating from one or more distributed transaction sources;
normalizing and serializing the received transaction events into a structured transaction stream;
dynamically constructing, for each monitored entity, one or more transaction windows having adjustable temporal and event-based boundaries, wherein the boundaries are determined in real time based on observed transaction behavior associated with the monitored entity;
correlating transaction attributes contained within each dynamically constructed transaction window with historical behavioral representations stored for the monitored entity;
computing a fraud risk state for each dynamically constructed transaction window based on the correlation; and
generating, in response to the computed fraud risk state, a transaction control decision comprising approval, rejection, or conditional verification of a corresponding transaction; wherein dynamically constructing the transaction windows comprises adjusting at least one of a transaction window duration, a transaction window event count, and a transaction window overlap parameter in response to changes in transaction frequency, transaction value dispersion, or inter-transaction timing variability; wherein dynamically constructing the transaction windows further comprises generating multiple concurrent transaction windows for a single monitored entity, each transaction window corresponding to a different temporal resolution, and performing fraud risk computation independently for each concurrent transaction window; wherein correlating transaction attributes with historical behavioral representations comprises retrieving adaptive behavioral baselines that evolve over time based on previously verified transaction outcomes associated with the monitored entity; and wherein computing the fraud risk state comprises evaluating transaction attribute relationships across dynamically evolving transaction windows rather than across fixed-duration transaction intervals.

2. The method of claim 1, wherein computing the fraud risk state further comprises assigning context-dependent weights to transaction attributes based on transaction channel, device characteristics, geographic indicators, and historical entity behavior; wherein generating the transaction control decision comprises dynamically adjusting a fraud decision threshold based on an aggregated trend of fraud risk states computed across successive transaction windows associated with the monitored entity.

3. The method of claim 1, further comprising distributing dynamically constructed transaction windows and corresponding fraud risk computations across a plurality of processing nodes within a cloud computing environment while maintaining consistency of transaction window state; wherein distributing the transaction windows comprises allocating processing resources based on a computed complexity indicator derived from transaction density within each transaction window; and further comprising replicating transaction window state information across multiple storage locations to preserve continuity of fraud analysis during processing node failures.

4. The method of claim 1, wherein dynamically constructing the one or more transaction windows for each monitored entity comprises executing, by the cloud-based computing system, a continuous window adaptation routine that includes: maintaining, in an entity-specific state store, a time-ordered buffer of recent transaction timestamps extracted from the structured transaction stream; computing, for each newly received transaction event, a rolling inter-transaction interval series using differences between successive timestamps stored in the buffer; determining a short-term interval distribution from the rolling inter-transaction interval series; comparing the short-term interval distribution against a longer-term reference interval distribution previously derived for the monitored entity; and adjusting a temporal boundary of an active transaction window by expanding or contracting a window start time or window end time in response to a quantified divergence between the short-term interval distribution and the longer-term reference interval distribution; and wherein adjusting the temporal boundary further comprises computing a divergence score by evaluating changes in central tendency and dispersion of the rolling inter-transaction interval series relative to the longer-term reference interval distribution, mapping the divergence score to a window adjustment factor using a predefined scaling function stored in memory, and applying the window adjustment factor to modify the temporal boundary while preserving chronological ordering of transaction events within the transaction window.

5. The method of claim 1, wherein dynamically constructing the one or more transaction windows further comprises dynamically controlling an event-based boundary by performing the steps of: tracking a cumulative transaction count and cumulative transaction value within each active transaction window; computing a rolling value dispersion metric from transaction amounts within the transaction window; comparing the rolling value dispersion metric to an entity-specific dispersion baseline maintained in the behavioral representations; incrementally increasing an allowable event count threshold when the rolling value dispersion metric remains within a predefined tolerance band; and decrementally reducing the allowable event count threshold when the rolling value dispersion metric exceeds the tolerance band, such that the event-based boundary adapts continuously during window formation.

6. The method of claim 1, wherein generating multiple concurrent transaction windows for the single monitored entity comprises instantiating, in parallel, a plurality of window instances each associated with a distinct temporal sensitivity parameter, storing transaction membership for each window instance in separate window-specific data structures, and independently updating the temporal and event-based boundaries of each window instance based on transaction behavior observed within the respective window instance rather than sharing fixed boundary parameters across the plurality of window instances; and wherein performing fraud risk computation independently for each concurrent transaction window comprises executing, for each window instance, a separate attribute correlation pipeline that retrieves only historical behavioral representations corresponding to the temporal sensitivity parameter of the respective window instance, computes a window-specific fraud risk state, and associates the computed fraud risk state with a window identifier and timestamp prior to any aggregation across window instances.

7. The method of claim 1, wherein correlating transaction attributes contained within each dynamically constructed transaction window with historical behavioral representations comprises transforming raw transaction attributes into normalized attribute vectors using entity-specific normalization parameters, partitioning the normalized attribute vectors into contextual attribute groups corresponding to transaction channel context, device context, and geographic context, and performing correlation operations independently for each contextual attribute group against corresponding segments of the historical behavioral representations; and wherein retrieving the adaptive behavioral baselines comprises selecting, from a plurality of stored baseline versions associated with the monitored entity, a baseline version corresponding to a current behavioral phase of the monitored entity determined from previously verified transaction outcomes, and excluding baseline versions associated with behavioral phases identified as anomalous or fraudulent.

8. The method of claim 1, wherein computing the fraud risk state for each dynamically constructed transaction window comprises generating a plurality of intermediate risk indicators corresponding to different transaction attribute relationships observed within the transaction window, temporally aligning the intermediate risk indicators based on transaction occurrence times, and combining the temporally aligned intermediate risk indicators into the fraud risk state using an aggregation sequence that preserves contribution order of transaction events within the transaction window.

9. The method of claim 2, wherein assigning context-dependent weights to transaction attributes comprises computing, for each transaction attribute, a context relevance score derived from historical frequency of attribute variation within the same transaction channel, device characteristics, and geographic indicators, updating the context relevance score over time based on feedback from previously verified transaction outcomes, and applying the updated context relevance score as a dynamic weighting factor during fraud risk state computation; and wherein dynamically adjusting the fraud decision threshold comprises maintaining a rolling sequence of fraud risk states computed across successive transaction windows for the monitored entity, calculating a trend indicator representing directional change in fraud risk across the rolling sequence, and modifying the fraud decision threshold incrementally in response to the trend indicator while enforcing predefined upper and lower threshold bounds stored in the cloud-based computing system.

10. The method of claim 3, wherein distributing the dynamically constructed transaction windows across the plurality of processing nodes comprises partitioning transaction windows based on entity identifiers, assigning each partition to a processing node together with the corresponding entity-specific state store, and synchronizing updates to transaction window boundaries using versioned state updates propagated across the plurality of processing nodes to prevent divergence in transaction window construction during parallel execution; and wherein replicating transaction window state information comprises periodically checkpointing, for each transaction window, a snapshot including window boundaries, transaction membership, and intermediate fraud risk indicators, storing the snapshot in at least two geographically distinct storage locations, and restoring the snapshot on reassignment of a transaction window to a different processing node following a detected processing node failure.

11. The method of claim 1, wherein normalizing and serializing the received transaction events into the structured transaction stream comprises extracting heterogeneous transaction fields originating from different transaction sources, converting the extracted fields into a common canonical representation using source-specific transformation rules stored in the cloud-based computing system, assigning a monotonically increasing sequence identifier to each normalized transaction event, and serializing the normalized transaction events into a time-ordered stream while preserving original transaction arrival order across distributed sources; and wherein dynamically constructing the one or more transaction windows further comprises maintaining, for each monitored entity, a mutable window state object comprising current window boundaries, transaction membership indices, and window-specific behavioral metrics, updating the mutable window state object incrementally upon arrival of each new transaction event, and recalculating the window boundaries without reprocessing previously ingested transaction events.

12. The method of claim 1, wherein adjusting the transaction window overlap parameter comprises determining an overlap ratio between successive transaction windows based on a measured rate of change in transaction behavior, increasing the overlap ratio when successive transaction windows exhibit rapid changes in transaction attributes, and decreasing the overlap ratio when successive transaction windows exhibit stable transaction behavior, such that overlapping windows selectively share transaction events during periods of behavioral instability; and wherein correlating transaction attributes with historical behavioral representations further comprises aligning transaction attributes within the dynamically constructed transaction window to corresponding temporal segments of the historical behavioral representations, compensating for differences in transaction density by resampling historical behavioral data to match a temporal granularity of the transaction window, and performing correlation using the temporally aligned data rather than raw historical records.

13. The method of claim 1, wherein retrieving the adaptive behavioral baselines comprises maintaining multiple baseline states for the monitored entity corresponding to different transaction contexts, selecting a baseline state based on a dominant transaction context inferred from the transaction attributes within the transaction window, and excluding baseline states associated with transaction contexts not present within the transaction window.

14. The method of claim 1, wherein computing the fraud risk state for each dynamically constructed transaction window further comprises generating intermediate attribute deviation values by comparing transaction attributes within the transaction window to corresponding attributes in the selected adaptive behavioral baseline, aggregating the intermediate attribute deviation values over a progression of transaction events within the window, and updating the fraud risk state incrementally as additional transaction events are incorporated into the transaction window.

15. The method of claim 2, wherein assigning the context-dependent weights to transaction attributes comprises computing a channel-specific relevance profile for each transaction channel using historical transaction outcomes, computing a device-specific stability profile using observed consistency of device characteristics over time, computing a geographic variability profile using historical location change frequency, and combining the relevance profile, stability profile, and variability profile to derive the context-dependent weights applied during fraud risk computation; and wherein dynamically adjusting the fraud decision threshold further comprises storing a threshold adjustment history associated with the monitored entity, limiting a rate of threshold change based on the threshold adjustment history to prevent abrupt threshold shifts, and applying the adjusted fraud decision threshold only after a minimum number of successive transaction windows exhibit a consistent fraud risk trend.

16. The method of claim 1, wherein generating the transaction control decision further comprises producing a conditional verification decision by identifying a subset of transaction attributes contributing most significantly to the computed fraud risk state, selecting one or more verification actions corresponding to the identified subset of transaction attributes, and associating the selected verification actions with the corresponding transaction prior to issuing the transaction control decision; and wherein evaluating transaction attribute relationships across dynamically evolving transaction windows comprises maintaining a cross-window relationship map that tracks attribute correlations across overlapping transaction windows, updating the cross-window relationship map as window boundaries change, and incorporating the tracked cross-window attribute correlations into the fraud risk state computation in addition to correlations observed within a single transaction window.
